(19) United States
(12) Patent Application Publication
(10) Pub. No.: US 2018/0115800 A1
(43) Pub. Date: Apr. 26, 2018

(54) NON-TRANSITORY COMPUTER READABLE MEDIUM AND DEVICE

(71) Applicant: FUJI XEROX CO., LTD., Tokyo (JP)

(72) Inventor: Ryosuke MASUKO, Kanagawa (JP)

(73) Assignee: FUJI XEROX CO., LTD., Tokyo (JP)

(21) Appl. No.: 15/590,485

(22) Filed: May 9, 2017

(30) Foreign Application Priority Data
Oct. 26, 2016 (JP) 2016-209314

(51) Int. Cl. H04N 21/431; H04N 5/445; H04N 21/426; G06T 13/80

(52) U.S. Cl. CPC H04N 21/4312; H04N 5/44513; H04N 2005/44569; G06T 13/80; H04N 2005/44517; H04N 21/42653

(57) ABSTRACT

A non-transitory computer readable medium storing a program causing a computer to execute a process, which includes: detecting a notification target state of a device including a sensor or a processing mechanism, the state requiring notification to a user, based on a signal from the sensor or the processing mechanism; upon detection of the notification target state, applying control to display in animation a transition from a state where a display element for notifying the user of the notification target state is not displayed on an operation screen to a state where the display element is completely displayed; and to display a second display element in response to a user operation on a first display element displayed on the operation screen, the second display element corresponding to the user operation, applying control to promptly display the second display element on the operation screen in response to the user operation.

### CROSS-REFERENCE TO RELATED APPLICATIONS

This application is based on and claims priority under 35 USC 119 from Japanese Patent Application No. 2016-209314 filed Oct. 26, 2016.

### BACKGROUND

### (i) Technical Field

The present invention relates to a non-transitory computer readable medium and a device.

### (ii) Related Art

Operation screens of electronic devices such as printers, scanners, copy machines, facsimile machines, multifunctional peripherals (devices with the printer, scanner, and copy machine ions), kiosk terminals, and video devices that use graphical user interface (GUI) are in the mainstream. Not a few devices use touchscreens as operation screens. This type of device detects a user's touch operation on a display element displayed on an operation screen, controls the operation of each unit included in the device in accordance with the detected operation, and causes details displayed on the operation screen to transition (such as displaying a new display element).

In recent years, there are an increasing umber of devices that display in animation the transition of displayed details of the operation screen in accordance with a user operation. Animated displaying includes, for example, displaying in animation a banner displaying a message to a user such that the banner gradually rises appearing from the bottom end of the display screen. The screen transition displayed in animation is easy for the user to understand intuitively. Animated displaying also attracts the user's attention since it involves movement of the displayed details of the screen, and this also helps the user recognize the transition (switching) of the displayed screen. This point leads to a decrease in errors in user operations involved in the screen transition. For example, if the screen transitions when a user tries to touch a button on the screen, the user may not recognize the transition and touch a different button after the transition, resulting in an operation error. This type of operation error becomes less likely to occur by displaying in animation the screen transition to make it easier for the user to recognize the screen transition.

However, animated displaying involves a predetermined play time, during which the user is unable to perform the next operation. Therefore, animated displaying is one of the causes of an extended operation time for the user to operate the device.

Displaying all screen transitions in animation makes it easier for the user to recognize them, but involves an increase in the operation time of the device, if all screen transitions are displayed without using animation, the time for operating the device becomes shorter, but the user may have difficulty understanding the screen transitions.

### SUMMARY

According to an aspect of the invention, there is provided a non-transitory computer readable medium storing program causing a computer to execute a process. The process includes: detecting a notification target state that is a state of a device including a sensor or a processing mechanism, the state requiring notification to a user, on the basis of a signal from the sensor or the processing mechanism; upon detection of the notification target state, applying control to display in animation a transition from a state in which a display element for notifying the user of the notification target state is not displayed on an operation screen of the device to a state in which the display element is completely displayed on the operation screen; and to display a second display element in response to a user operation on a first display element displayed on the operation screen, the second display element corresponding to the user operation, applying control to promptly display the second display element on the operation screen in response to the user operation.

### BRIEF DESCRIPTION OF THE DRAWINGS

An exemplary embodiment of the present invention will be described in detail based on the following figures, wherein:

FIG. 1 is a diagram illustrating the functional configuration of a device according to an exemplary embodiment;

FIG. 2 includes illustrations of an example of a screen transition in accordance with a user operation;

FIG. 3 includes illustrations of an example of a screen transition for notifying a user of the state of the device;

FIG. 4 is a flowchart illustrating an example of the procedure of a process performed by a screen display manager;

FIG. 5 is an illustration of an example of determination information used by the screen display manager to determine a display trigger of a display element;

FIG. 6 includes illustrations of an example of a screen transition in the case of displaying a display element including an operation reception element according to a modification;

FIG. 7 is an illustration of an example of a screen newly displayed in response to pressing of the operation reception element; and

FIG. 8 includes illustrations of an example of a screen transition in the case of displaying a screen including no operation reception element.

### DETAILED DESCRIPTION

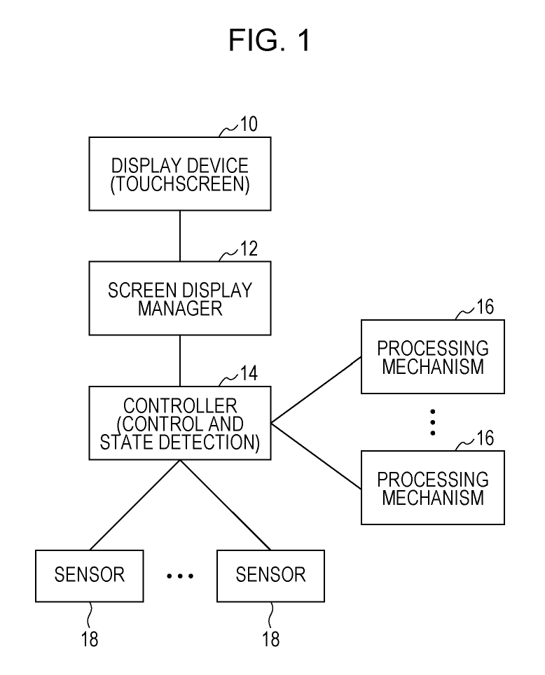

Referring to FIG. 1, an example of the functional configuration of a device according to an exemplary embodiment will be described. This device is a device for providing a user with processing executed by one or more processing mechanisms 16. The type of device is not particularly limited, and the device may be any device such as a printer, a scanner, a copy machine, a facsimile machine, a multifunctional peripheral (device with the printer, scanner, and copy machine functions), a kiosk terminal, an image capturing device, or a video device. When the device is a multifunctional peripheral by way of example, the device includes a print mechanism, a scan mechanism, and an information processing mechanism for job management, which are the processing mechanisms 16. The device may include multiple processing mechanisms 16, such as the print mechanism and the scan mechanism.

A display device 10 is a device that displays display information for a user interface of the device. In this example, a screen of the display device 10 is a touchscreen that detects a position on the screen that a user's finger or the like contacts (touches).

A screen display manager 12 generates display information for a user interface screen in the GUI format, which receives an instruction for operating the device, and supplies the display information to the display device 10, and the display device 10 displays the supplied display information. The user interface screen is referred to as an operation screen. The operation screen includes display elements such as the background, one or more windows, one or more icons, one or more menus, and one or more buttons. The screen display manager 12 detects a user operation on a display element within the operation screen on the basis of a signal indicating a touched position from the display device 10 (touchscreen), notifies a controller 14 of an instruction indicated by the user operation, and updates the displayed details of the operation screen in accordance the user operation.

The controller 14 controls each processing mechanism 16 in the device to execute processing corresponding to a user operation input. The controller 14 receives notifications from the individual processing mechanisms 16, such as feedback or the operation state including the occurrence of an error, and grasps the state of the processing mechanisms 16 at all times on the basis of the notifications.

Sensors 18 for detecting the state of the individual units of the device are provided in the device. The sensors 18 are types of sensors suitable for detecting the state of the individual to-be-monitored targets. For example, when the device is a multifunctional peripheral, examples of the sensors 18 provided in the print mechanism, which is one of the processing mechanisms 16, include a paper detection sensor provided at each portion of a paper transport path, a sensor that detects the remaining amount of paper on a paper feed tray, and a sensor that detects the remaining amount of toner of each color. The controller 14 detects the state of a portion corresponding to each sensor 18 from a signal sent from the sensor 18.

Operation screens generated by the screen display manager 12 include, for example, a main menu screen that indicates a list of functions (processes) provided by the device, and function screens for setting one or more parameters of the individual functions. A screen displayed on the display device 10 transitions in accordance with an event serving as a trigger. Trigger events for a screen transition include a user operation, and device states detected by the controller 14 from signals from the processing mechanisms 16 and the sensors 18. For example, when the user presses (touches) a button indicating a copy function on the main menu screen displayed on the display device 10 of the multifunctional peripheral, the screen display manager 12 causes the operation screen displayed on the display device 10 to transition from the main menu screen to the function screen of the copy function. Alternatively, when the controller 14 detects that the remaining amount of toner of a certain color has become less than or equal to a warning threshold on the basis of a signal from the remaining-amount sensor of toner of that color, the controller 14 displays, within the operation screen being displayed by the display device 10, a display element such as a banner displaying a warning message that the toner's remaining amount has become low.

A “transition” of the operation screen displayed on the display device 10 includes various modes, such as the case where the entire operation screen switches to another operation screen (that is, the entire display area of the display device 10 switches from one screen to another), the case where the entirety of a portion of the operation screen excluding a portion that fixedly displays a particular display element switches from one display to another, the case where one or more new display elements are additionally displayed on the displayed operation screen, and the case where a display element within the displayed operation screen changes (such as when the display element disappears or a message indicated in the display element changes to another message).

In the exemplary embodiment, when a transition of the operation screen displayed on the display device 10 is one that corresponds to a user operation on the operation screen, the screen display manager 12 executes that transition by immediately switching the displayed details of the operation screen, instead of displaying the transition in animation. When a transition of the operation screen is one for notifying the user of a device state detected by the controller 14, the screen display manager 12 displays the transition in animation. Hereinafter, both cases will be described in detail.

(1) Screen Transition in Accordance with User Operation

When a transition of the operation screen is one that directly corresponds to a user operation, the screen display manager 12 immediately switches the displayed details of the operation screen from a pre-transition display state to a post-transition display state without using animation. That is, in this case, an operation screen displayed at a time point when an operation serving as a trigger for the transition immediately switches to a post-transition operation screen corresponding to the operation. In this case, because the user causes the screen to switch in response to his/her operation in order to progress work using the device, the shorter the time involved in the screen transition, the shorter the time involved in the work, which is beneficial for the user. The user is expected to grasp what kind of screen the post-transition screen will be in response to the operation, and it is considered that an operation error involved in the screen transition, such as a touching error, is less likely to occur even if the screen is immediately switched (that is, even if the screen transition is displayed without using animation, which takes time).

Here, the “immediate” switching of the operation screen refers to displaying a post-transition operation screen corresponding to a transition trigger (in this case, reception of a user operation) after an operation screen displayed at a time point when the trigger occurs, without displaying an animation representing the screen transition in between the pre-transition screen and the post-transition operation screen. A screen transition in which the displayed operation screen is immediately switched to a post-transition display state without displaying an animation in between is referred to as a “non-animated transition”. Meanwhile, a screen transition in which a display element to be newly displayed on the display device 10 is displayed in animation from a state where the display element is not displayed to a state where the display element is completely displayed is referred to as an “animated transition”. Note that a state in which a display element is “completely” displayed refers to a display state of the display element in which the transition is completed and the screen has entered a stationary display state.

A transition that directly corresponds to a user operation refers to a transition in the case where the operation and a display element newly displayed after the transition (this display element may be the entire operation screen newly displayed after the transition) have a predetermined one-to-one relationship. For example, this type of transition includes a case where, when the user presses a GUI button on the operation screen, a display element programmed to be called in response to pressing of the GUI button is newly displayed on the screen.

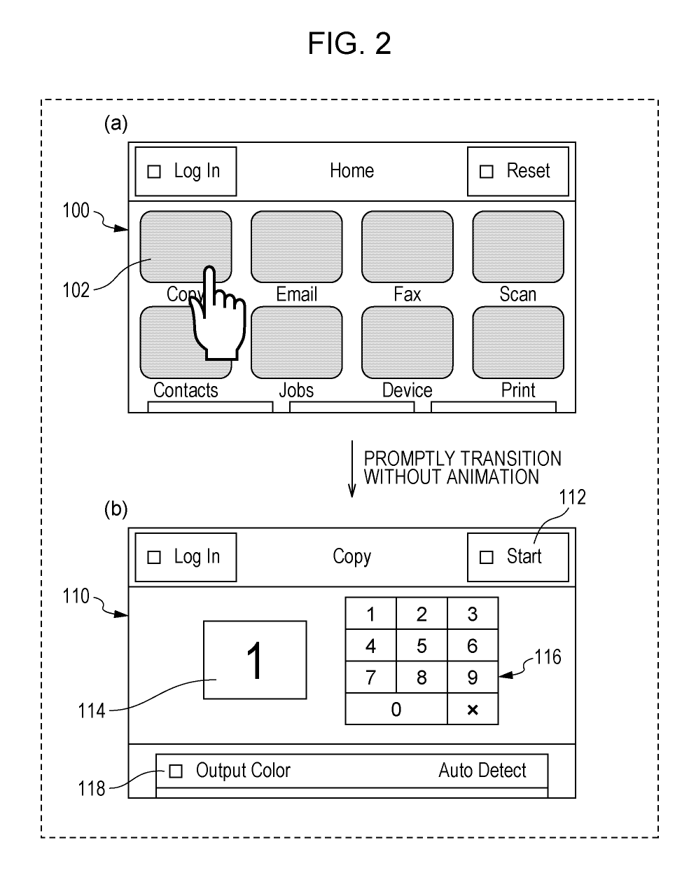

FIG. 2 illustrates an example of the case where a screen transition in accordance with a user operation is performed as a non-animated transition. This example is an example of the screen display of the display device 10 in the case where the device is a multifunctional peripheral. Part (a) schematically illustrates a main menu screen 100 of the multifunctional peripheral, in which a group of GUI buttons for calling function screens for giving instructions to execute functions including copy (Copy), email transmission (Email), facsimile transmission (Fax), and so forth is arranged. When the user presses (touches) a copy (Copy) button 102 within the main menu screen. 100 with his/her finger, as illustrated in part (b), a copy screen 110 for performing various settings for the copy function displayed on the display device 10. This display transition from the main menu screen 100 to the copy screen 110 is a transition in which the copy screen 110, which is a display element that directly corresponds to the user operation of pressing the copy button 102, is newly displayed in response to the user operation. Accordingly, this display transition is immediately executed as a non-animated transition.

The copy screen 110 displays, although this is only exemplary, a start button 112 for giving an instruction to start copying, a number-of-copies field 114 indicating the number of copies, a numeric keypad 116 for inputting the number of copies displayed in the number-of-copies field 114, and a group of setting items 118 for displaying the values of individual setting items regarding copying and calling dialogues for changing the values. Although only one setting item 118 is displayed in the illustrated display state, other setting items 118 arranged below the displayed setting item 118 will also be displayed by scrolling the copy screen 110.

At the time of displaying a display element that directly corresponds to a user operation in response to the user operation, or instead of that “directly corresponding display element”, a different display element may be displayed on the display device 10. Such a “different display element” differs from one expected by the user to be displayed in response to a user operation. Accordingly, this different display element is displayed using an animated transition, instead of a non-animated transition.

For example, when the user presses the output color mode setting item 118 within the copy screen 110, normally a display element (such as a dialogue indicating choices of the mode) for receiving selection of the output color mode (such as monochrome or full colors) is displayed on the display device 10. At this point, if the amount of any color toner necessary for full-color printing is less than or equal to a threshold, to call the user's attention, a display element (such as a banner) for notifying the user of the fact that the remaining amount of the toner is low is displayed along with or instead of the display element for selecting the color mode on the display device 10. Although the display element indicating that the remaining amount of the toner is low is displayed in response to a trigger that is a user operation of pressing the output color mode setting item 118, the display element is not directly associated with the operation of pressing the setting item 118 (in other words, the display element is not expected by the user, who has pressed the setting item 118, to be displayed in response to pressing of the setting item 118). Therefore, the display element indicating that the remaining amount of the toner is low is displayed using an animated transition in order to call more attention of the user's.

### (2) Screen Transition for Notifying User of Device State

Upon detection by the controller 14 of a predetermined device state serving as a notification target for the user (referred to as a “notification target state”; this corresponds to, for example, a state where something is wrong with a notification target) on the basis of signals from the processing mechanisms 16 and the sensors 18, the screen display manager 12 according to the exemplary embodiment performs a screen transition for notifying the user of the notification target state. This screen transition is performed by newly displaying, on the display device 10, a particular display element (referred to as a notification target element) for notifying the user of the occurrence of the notification target state. The notification target element may be an element such as a banner additionally displayed in a portion of the operation screen being displayed, or a notification screen covering the entire screen of the display device 10 (such as a screen displaying a message describing the state).

A screen transition in the case of newly displaying a notification target element is an animated transition. That is, the screen display manager 12 displays in animation a change of the screen from an operation screen immediately before the transition starts (the notification target element has not been displayed yet) to a state in which the notification target element is completely displayed (that is, a state of the operation screen after the transition is completed). The user's attention to such a notification target element not expected by the user to be displayed is called by taking time and displaying the notification target element in animation.

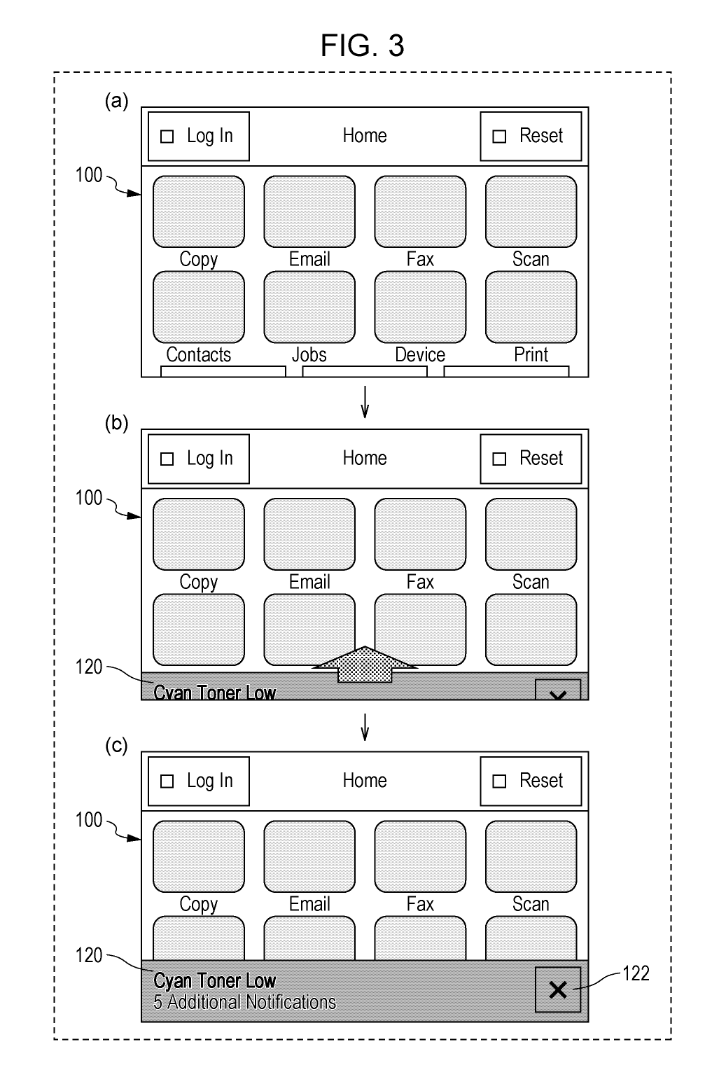

FIG. 3 illustrates an example of displaying a notification target element using an animated transition. In this example, part (a) illustrates the state of the main menu screen 100 displayed by the display device 10 before a notification target state is detected. At this state, if the controller 14 detects the notification target state that “the remaining amount of the toner ‘Cyan’ is less than or equal to a threshold”, a banner 120 which is a notification target element indicating that fact is displayed at the bottom end of the main menu screen 100 The screen transition in this case is represented as an animation that represents the banner 120, which gradually comes out from the bottom end of the main menu screen 100 while sliding, as illustrated in part (b). Part (c) illustrates a state in which the screen transition is completed and the banner 120 is completely displayed. Thereafter, the display state of the banner 120 remains unchanged until another trigger event for causing the displaying of the banner 120 to further transition (such as an event that a certain time elapses after the banner 120 is completely displayed or a button 122 giving an instruction to erase the banner 120 is pressed) occurs.

Note that the screen display manager 12 may be configured to receive no user operation on the operation screen from the start to the end of an animated transition in the case of displaying a notification target element. In doing so, an operation error such as a user, who is trying to touch a display element before the transition, touching a display element after the transition becomes less likely to occur. Here, a range in which no operation is accepted may be limited to a range where a notification target element is displayed.

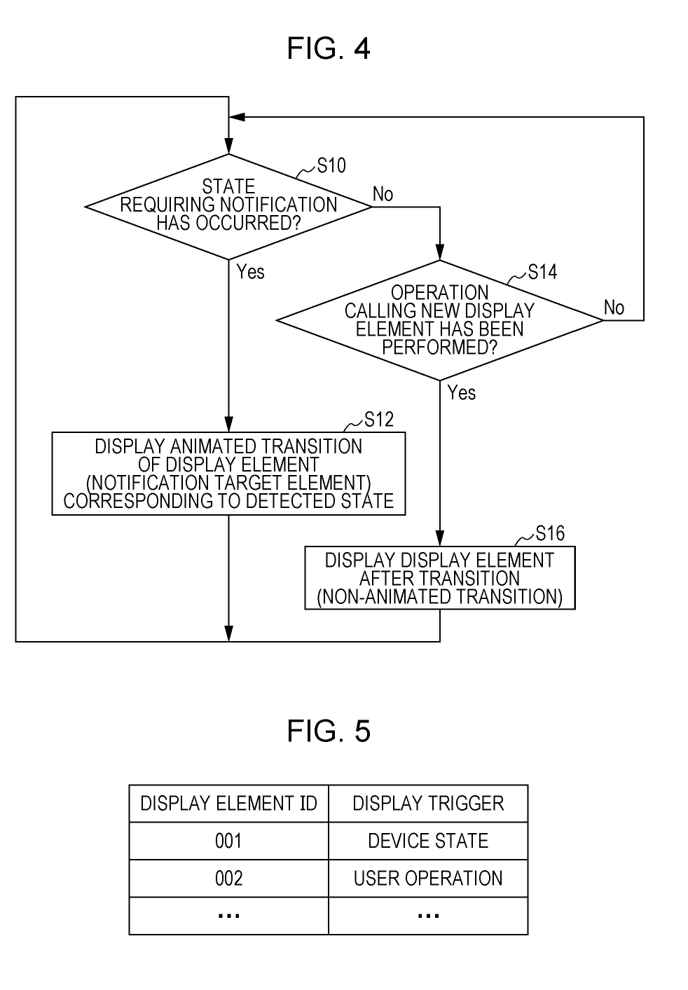

An example of a process executed by the screen display manager 12 to realize the above-described screen transition will be described with reference to FIG. 4.

The controller 14 monitors signals from the processing mechanisms 16 and the sensors 18 at all times. If a state that is necessary for the user to be notified of occurs in any portion of the device, the controller 14 detects this state, and sends information specifying the detected state to the screen display manager 12. The screen display manager 12 determines whether a notification of this information has arrived from the controller 14 (S10). On receipt of the information (the determination result in S10 is YES), the screen display manager 12 displays a notification target element notifying the user of the state indicated by the information on the display device 10 using an animated transition (S12).

The screen display manager 12 waits for the arrival of a signal indicating a touch operation performed by the user from the display device 10 (touchscreen). On receipt of a signal indicating a touch operation, the screen display manager 12 determines whether the operation indicated by the signal indicates an instruction to display a new display element on the screen (S14). If the determination result is YES, the screen display manager 12 displays that new display element on the screen of the display device 10 using a non-animated transition (that is, promptly displays the new display element without using an animation) (S16). If the determination result is NO, the screen display manager 12 again determines whether a state that is necessary for the user to be notified of occurs (S10).

In another example, the screen display manager 12 may perform the following control, instead of dynamically determining the relationship between the arrival of a signal from the controller 14 or the display device 10 and a display element to be newly displayed in accordance with that signal, and determining whether to display the screen transition in animation, as illustrated in the procedure of the process illustrated in FIG. 4. That is, in this example, as illustrated in FIG. 5, the screen display manager 12 has determination information indicating, in association with identification information (“display element IDs”) of the individual display elements, whether an event triggering displaying each display element is a user operation or the occurrence of a device state requiring notification. In the case of displaying a new display element in accordance with a user operation on the display device 10 or a device state whose notification is sent from the controller 14, the screen display manager 12 refers to the determination information and determines whether a trigger of the display element is a user operation or a device state. If the trigger is a user operation, the screen display manager 12 displays the display element using a non-animated transition; and if the trigger is a device state, the screen display manager 12 displays the display element using an animated transition.

In yet another example, if each display element in a program representing the screen display manager 12 is called by a user operation, the display element may be programmed as a non-animated transition element; and if each display element is called accordance with a device state, the display element may be programmed as an animated transition element. In this case, if a display element in the program is called in accordance with a user operation on the display device 10 or a device state whose notification is sent from the controller 14, the screen display manager 12 realized by executing the program may execute a program of that display element. If the executed display element is a non-animated transition display object, the display element is displayed on the screen using a non-animated transition. If the executed display element is programmed as an animated transition display object, the display element is displayed on the screen using an animated transition.

Next, modifications will be described.

In one modification, if a display element to be newly displayed on the display device 10 in accordance with a trigger includes an element receiving an operation from the user (referred to as an operation reception element), the screen display manager 12 displays that display element using an animated transition. By enabling the user to more easily recognize the appearing of the new display element using an animated transition, an operation error becomes less likely to occur. That is, if the new display element is promptly displayed using a non-animated transition in such a case, an operation error that the user, who is trying to touch a display element before the transition, actually touches an operation reception element in the new display element becomes likely to occur. In contrast, if a display element including an operation reception element is displayed using an animated transition, it becomes easier for the user to recognize the transition, and such an operation error becomes less likely to occur.

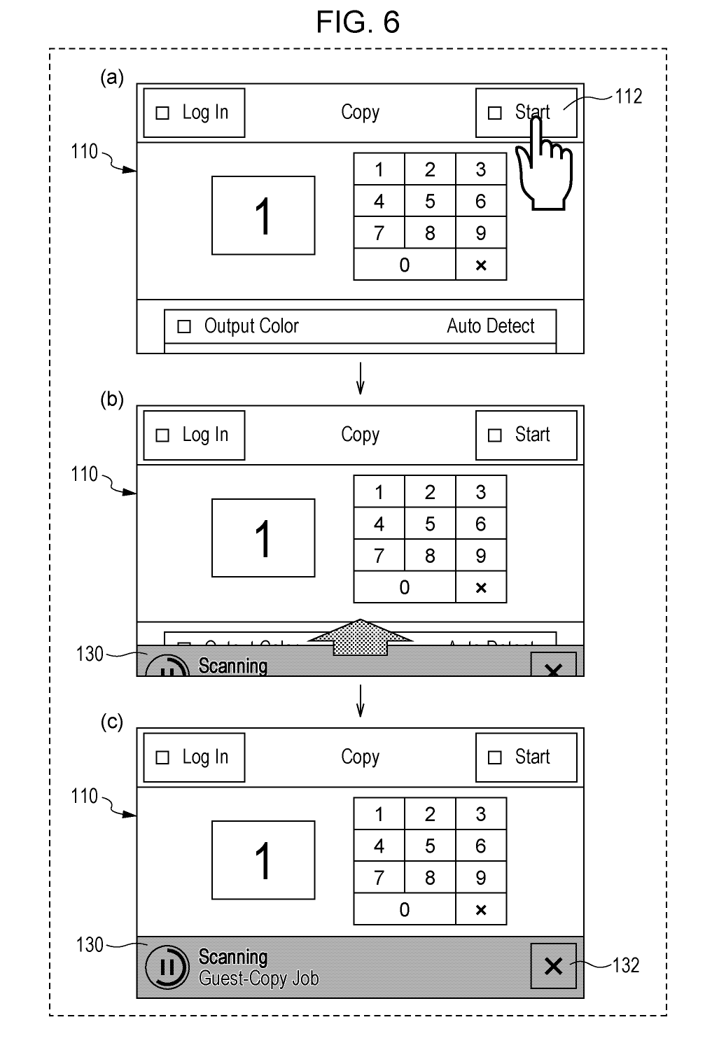

FIG. 6 illustrates an example in which a display element including an operation reception element is displayed. In this example, when the device starts a copy job in response to the user's pressing of the start button 112 on the copy screen 110 (part (a) of FIG. 6), the controller 14 notifies the screen display manager 12 of the progress of the copy job. In response to this, the screen display manager 12 displays a display element (banner 130) for notifying the user of the progress at the bottom end of the copy screen 110 (part (c) of FIG. 6). When starting displaying the banner 130, the screen display manager 12 causes, using an animation, the banner 130 to appear from the bottom end of the copy screen 110 while sliding (part (b) of FIG. 6). The banner 130 displays, as information indicating the progress, the type of job being executed (“copy job” in this example), information on the user who has designated the job (“guest” in this example), and the status of the currently executed job (“scanning” indicating that the to-be-copied document is being scanned).

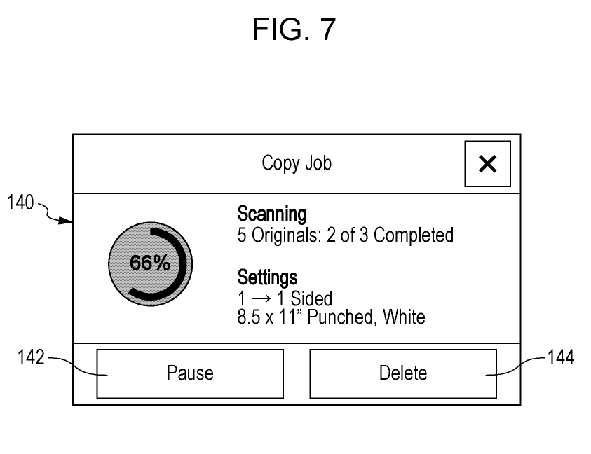

After animated displaying of the banner 130 at the time of its appearance ends and the banner 130 completely appears, if the user touches a portion other than an erase button 132 (a rectangle enclosing x) within the banner 130, a detailed progress screen 140 illustrated in FIG. 7 is displayed on the display device 10. The detailed progress screen 140 is a display element displayed covering the entire copy screen 110. On the detailed progress screen 140, the following are displayed: the type of job being executed (“copy job” in this example), which is displayed as a title; information indicating the status of the currently executed job (in the illustrated example, the words representing that the to-be-copied document is being scanned, and ⅔ of the scanning of the 5-page document is completed); and details of the major settings of the job (in the illustrated example, the settings that the front side of the document is printed on the front side of paper, that the paper size is 8.5 inches×11 inches, and that the paper is to be punched). In addition, a pause button (“Pause”) 142 and a job delete button (“Delete”) 144 are displayed. In response to pressing of the pause button 142, the controller 14 pauses the currently executed job. In response to pressing of the job delete button 144, the controller 14 terminates the job at that point, and deletes the job from one or more jobs that are under management.

In the example illustrated in FIGS. 6 and 7, a display element that is the banner 130 includes an element receiving an operation for calling another display element that is the detailed progress screen 140 (an area other than the erase button 132 in the banner 130). At the time of its appearance, the banner 130 appears on the screen using an animated transition.

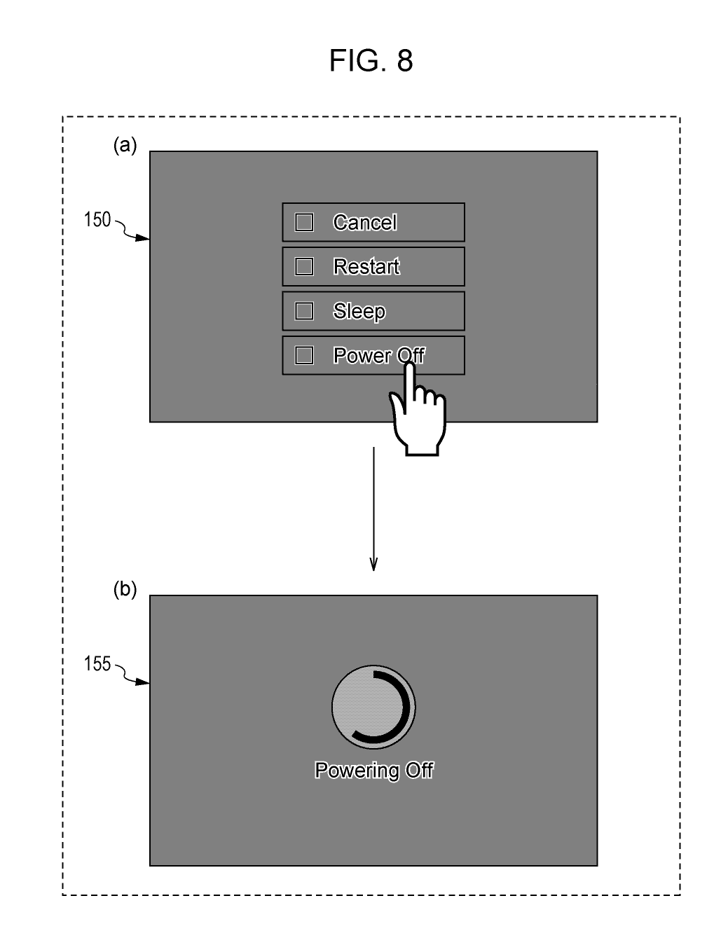

Another modification will be described with reference to FIG. 8. This modification may be combined with the above-described exemplary embodiment or modification.

In this modification, if a display element to be newly displayed on the display device 10 is a display element that does not receive an operation from the user (such as a display element that simply provides information), the screen display manager 12 displays that display element using a non-animated transition. Even if the user does not recognize the transition and touches a new display element after the transition thinking that there is a button before the transition, because that display element does not receive an operation from the user, no operation error occurs.

An operation screen 150 illustrated by way of example in part (a) of FIG. 8 is a screen for giving instructions to restart the device (“Restart”), to proceed to a power saving state (“Sleep”), and to turn off the power (“Power Off”). When the user presses, for example, the power off button on the display screen 150, the screen display manager 12 displays a screen 155 (part of FIG. 8) indicating that the display device 10 is being turned off. The screen 155 includes no element receiving an operation from the user. The screen display manager 12 performs the transition from the operation screen 150 to the screen 155 using a non-animated transition. That is, in response to pressing of the power off button on the operation screen 150, the screen displayed on the display device 10 is promptly switched from the operation screen 150 to the screen 155.

Although the case of turning off the power has been described above by way of example, for example, to display a preview screen (a screen where an image simulating a print result in the case of printing a document is displayed on the display device 10), since the preview screen includes no operation reception element, control may be applied to display the preview screen using a non-animated transition.

Although the example illustrated in FIG. 8 is an example in the case where the new screen 155 displayed in response to the user's pressing of a button includes no GUI part receiving a user operation, this is only exemplary. To newly display a display element reporting a device state, if that new display element includes no GUI part receiving a user operation, control may be applied to display that display element using a non-animated transition.

Although the exemplary embodiment and modifications of the present invention have been described above, these are only exemplary. For example, the following mode may be included in the scope of the present invention.

For example, one such example is a mode in which the screen display manager 12 displays a display element to be displayed in direct association with a user operation using a non-animated transition, and displays other display elements using an animated transition. Display elements other than those in direct association with user operations are often not expected by the user to be displayed; thus, displaying these display elements using an animated transition enables the user to more easily recognize these display elements. In another example, the screen display manager 12 may display a display element reporting a device state using an animated transition, and may display other display elements using a non-animated transition.

In the above examples, as a mode of animated transition, an animation in which a display element gradually appears in the operation screen from the end portion of the operation screen while sliding has been illustrated. However, as is apparent to those skilled in the art, an animated transition in the exemplary embodiment and the modifications may be represented using other modes of animation, such as a mode in which a to-be-displayed display element that is transparent becomes gradually less transparent and finally becomes opaque.

Information processing performed by a user interface (UI) mechanism of the above-illustrated device is realized by, for example, causing a computer to execute a program representing the above-described functions. Here, the computer includes, as hardware, a circuit configuration in which a microprocessor such as a central processing unit (CPU), a controller that controls a memory (primary storage) such as a random-access memory (RAM) and a read-only memory (ROM) and a secondary storage device such as a flash memory, a solid-state drive (SSD), or a hard disk drive (HDD), various input/output (I/O) interfaces, and a network interface that applies control for connections with a network such as a local area network (LAN) are connected via a bus. A program describing the details of processing of these functions is saved on the secondary storage device such as a flash memory via a network or the like, and installed on the computer. The program stored on the secondary storage device is read out to the RAN and executed by the microprocessor such as a CPU, thereby realizing the above-illustrated function module group.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer readable medium storing a program causing a computer to execute a process, the process comprising:
detecting a notification target state that is a state of a device including a sensor or a processing mechanism, the state requiring notification to a user, on the basis of a signal from the sensor or the processing mechanism;
upon detection of the notification target state, applying control to display in animation a transition from a state in which a display element for notifying the user of the notification target state is not displayed on an operation screen of the device to a state in which the display element is completely displayed on the operation screen; and
to display a second display element in response to a user operation on a first display element displayed on the operation screen, the second display element corresponding to the user operation, applying control to promptly display the second display element on the operation screen in response to the user operation.

2. The non-transitory computer readable medium according to claim 1, wherein, if the second display element includes an operation reception element receiving a user operation, control is applied to display in animation a transition from a state before the second display element is displayed to a state in which the second display element is completely displayed.

3. The non-transitory computer readable medium according to claim 1, wherein, if the display element for notifying the user of the notification target state includes no operation reception element receiving a user operation, control is applied to promptly display the display element on the operation screen in response to detection of the state.

4. A device comprising:
one or more sensors;
one or more processing mechanisms;
a detector that detects a notification target state that is a state of the device, the state requiring notification to a user, on the basis of a signal from the one or more sensors or the one or more processing mechanisms;
a first display controller that, upon detection by the detector of the notification target state, applies control to display in animation a transition from a state in which a display element for notifying the user of the notification target state is not displayed on an operation screen of the device to a state in which the display element is completely displayed on the operation screen; and
a second display controller that, to display a second display element in response to a user operation on a first display element displayed on the operation screen, the second display element corresponding to the user operation, applies control to promptly display the second display element on the operation screen in response to the user operation.

5. A non-transitory computer readable medium storing a program causing a computer to execute a process, the process comprising:
detecting a notification target state that is a state of a device including a sensor or a processing mechanism, the state requiring notification to a user, on the basis of a signal from the sensor or the processing mechanism;
upon detection of the notification target state, applying control to display in animation a transition from a state in which a display element for notifying the user of the notification target state is not displayed on an operation screen of the device to a state in which the display element is completely displayed on the operation screen; and
to display a display element corresponding to a trigger on the operation screen in response to the trigger, the trigger being other than detection of the notification target state of the device, applying control to promptly display the display element on the operation screen in response to the trigger.

6. A device comprising:
one or more sensors;
one or more processing mechanisms;
a detector that detects a notification target state that is a state of the device, the state requiring notification to a user, on the basis of a signal from the one or more sensors or the one or more processing mechanisms;
a first display controller that, upon detection by the detector of the notification target state, applies control to display in animation a transition from a state in which a display element for notifying the user of the notification target state is not displayed on an operation screen of the device to a state in which the display element is completely displayed on the operation screen; and
a second display controller that, to display a display element corresponding to a trigger on the operation screen in response to the trigger, the trigger being other than detection by the detector of the notification target state of the device, applies control to promptly display the display element on the operation screen in response to the trigger.

7. A non-transitory computer readable medium storing a program causing a computer to execute a process, the process comprising:
to display a second display element in response to a user operation on a first display element displayed on an operation screen of a device, the second display element corresponding to the user operation, applying control to promptly display the second display element on the operation screen in response to the user operation; and
to display a display element corresponding to a trigger on the operation screen in response to the trigger, the trigger being other than detection of a user operation on a display element displayed on the operation screen, applying control to display in animation a transition from a state before the display element corresponding to the trigger is displayed to a state in which the display element corresponding to the trigger is completely displayed.

8. The non-transitory computer readable medium according to claim 7, wherein, if the second display element includes an operation reception element receiving a user operation, control is applied to display in animation a transition from a state before the second display element is displayed to a state in which the second display element is completely displayed.

9. A device comprising:
a display device that displays an operation screen;
a first display controller that, to display a second display element in response to a user operation on a first display element displayed on the operation screen, the second display element corresponding to the user operation, applies control to promptly display the second display element on the operation screen in response to the user operation; and
a second display controller that, to display a display element corresponding to a trigger on the operation screen in response to the trigger, the trigger being other than detection of a user operation on a display element displayed on the operation screen, applies control to display in animation a transition from a state before the display element corresponding to the trigger is displayed to a state in which the display element corresponding to the trigger is completely displayed.

10. A non-transitory computer readable medium storing a program causing a computer to execute a process, the process comprising:
to display, on an operation screen of a device, a display element including an operation reception element receiving a user operation, applying control to display in animation a transition from a state before the display element is displayed to a state in which the display element is completely displayed; and
to display, on the operation screen, a display element including no operation reception element receiving a user operation, applying control to promptly display the display element on the operation screen in response to detection of a trigger for displaying the display element.

11. A device comprising:
a display device that displays an operation screen;
a first display controller that, to display, on the operation screen, a display element including an operation reception element receiving a user operation, applies control to display in animation a transition om a state before the display element is displayed to a state in which the display element completely displayed; and
a second display controller that, to display, on the operation screen, a display element including no operation reception element receiving a user operation, applies control to promptly display the display element on the operation screen in response to detection of a trigger for displaying the display element.
